(19) United States
(12) Patent Application Publication
(10) Pub. No.: US 2010/0034128 A1
(43) Pub. Date: Feb. 11, 2010

(54) TLV for Supporting DSx and R2 Signaling Procedures for MCBCS in WiMax Networks

(76) Inventors: Raymond Yim, Cambridge, MA (US); Zhifeng Tao, Allston, MA (US); Toshiyuki Kuze, Hiratsuka (JP)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/399,442

(22) Filed: Mar. 6, 2009

Related U.S. Application Data
(60) Provisional application No. 61/086,593, filed on Aug. 6, 2008.
(60) Provisional application No. 61/086,943, filed on Aug. 7, 2008.

(51) Int. Cl. H04H 20/71

(52) U.S. Cl. 370/312

(57) ABSTRACT

A method for signaling in a wireless network, including a base station (BS) in a cell, wherein the network operates according to the IEEE 802.16 standard, exchanges messages between a subscriber station (SS), when the SS enters the cell. The messages indicate whether the SS and the BS are enabled to use an Upper Layer Signaling (R2) and a Dynamic Service Addition/Change (DSA/DSC) signaling (DSx) for multi-cast broadcast services (MBS) for subsequent message exchanged between the SS and the BS, after the SS is admitted into the cell.

### RELATED APPLICATIONS

This Non-Provisional Application claims priority to Provisional Patent Applications 61/086,593, “TLV for Supporting DSx and Upper Layer Signaling Procedures for MCBCS in WiMax Networks,” filed by Yim et al. on Aug. 6, 2008, and 61/086,943, “TLV for Supporting DSx and Upper Layer Signaling Procedures for MCBCS in WiMax Networks,” filed by Yim et al. on Aug. 7, 2008, both incorporated herein by reference.

### FIELD OF THE INVENTION

This invention relates generally to wireless communication networks, and more particularly to signaling in Multicast-Broadcast (MBS) Services in the IEEE 802.16 and Worldwide Interoperability for Microwave Access (WiMAX) networks.

### BACKGROUND OF THE INVENTION

The Networking Working Group (NWG) in Worldwide Interoperability for Microwave Access (WiMax) Forum is considering two network architectures for supporting Multicast-Broadcast Services (MCBCS) in WiMAX networks. MCBCS is also referred to as multicast-broadcast service (MBS) in the IEEE 802.16 standard. MCBCS uses a Dynamic Service Addition/Change (DSA/DSC) signaling (DSx) procedure to establish service flow. MBS uses an Upper Layer Signaling (ULS), which is also referred to as the R2 interface signaling in the IEEE 802.16 standard.

It remains undecided whether the NWG will decide to support either the DSx or the ULS. Harmonization can support both procedures. In the case where the both procedures are supported, amendment should be made to the IEEE 802.16 Rev 2 standard, in order to enable a subscriber station (SS) and a base station (BS) to announce their capability of supporting MCBCS, through either or both procedures. SS is used interchangeably with mobile station (MS) in this description.

### SUMMARY OF THE INVENTION

The embodiments of the invention add novel features to the current Type-Length-Value (TLV) definitions in the IEEE 802.16 Rev 2 standard.

Generally, data communication protocols encode optional information as a type-length-value or TLV element in the protocol. The type and length fields are fixed in size (typically 1-4 bytes), and the value field is of variable size. These fields are used as follows.

Type: A numeric code which indicates the kind of field that this part of the message represents.

Length: The size of the value field (typically in bytes).

Value: Variable sized set of bytes which contains data for this part of the message.

There is a TLV 184 for the subscriber station (SS) Basic Capability Request (SBC-REQ) and the SS Basic Capability Response (SBC-RSP). The TLV 12 is for the Registration Request (REG-REQ), and Registration Response (REG-RSP).

SBC-REQ/RSP and REG-REQ/RSP messages are used when the SS enters and registers with the network. These features enable the base station (BS) and the SS to determine whether the Dynamic Service Addition/Change (DSx) procedure and/or the Upper Layer Signaling (ULS) procedure can be used to enable MCBCS. When the SS or the BS initiates the MCBCS, the SS can use either procedure if both the SS and the BS support both procedures.

### BRIEF DESCRIPTION OF THE DRAWINGS

FIG. 1 is a schematic of a wireless network using the embodiments of the invention; and

FIG. 2 is a flow diagram of a method for signaling according to embodiments of the invention in the network of FIG. 1;

### DETAILED DECRIPTION OF THE DRAWINGS

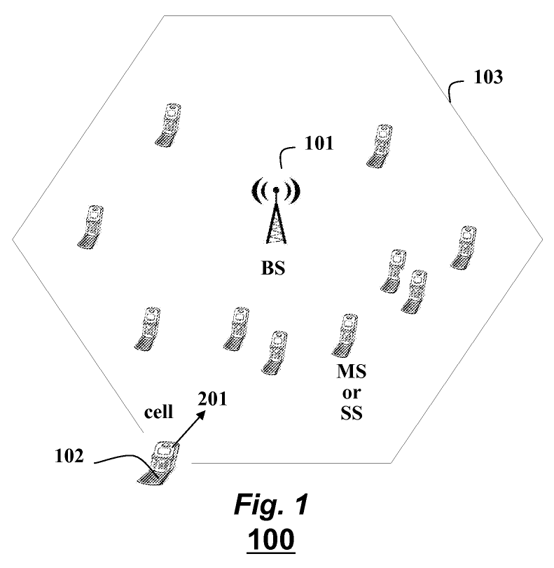

FIG. 1 shows a portion of a wireless network used by the embodiments of the invention. The network includes a base station (BS) serving a set of mobile stations (MS or subscriber stations (SS)) 102 in a cell 103.

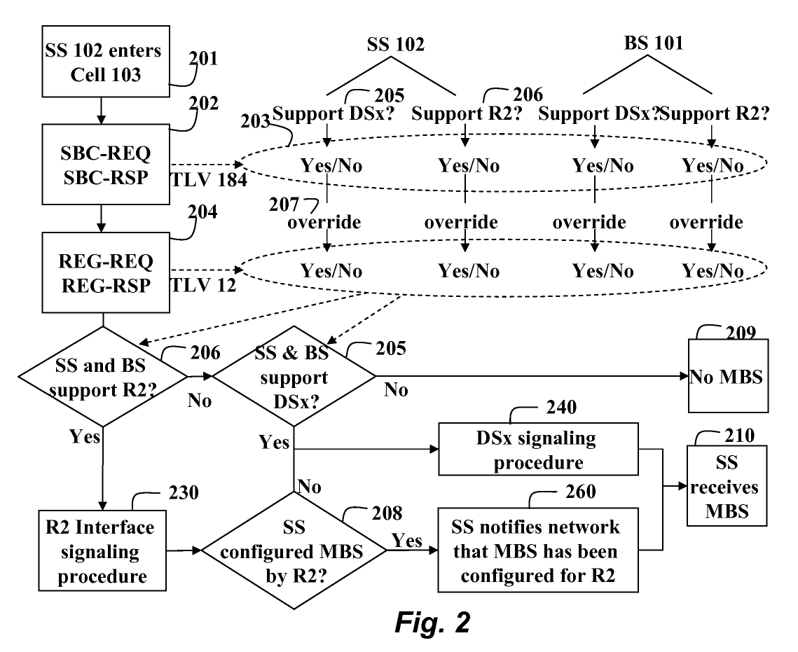

FIG. 2 shows the method for determining whether the DSx procedure and/or the R2 procedure is used to enable MCBCS. Two methods can be used to allow the BS and the SS to discover whether the DSx procedure and/or the Upper Layer Signaling procedure can be used to enable MCBCS.

TLV Indication in SBC-REQ/RSP

Type-Length-Value (TLV) field 184 in the current IEEE 802.16 standard defines extended capability that is used in subscriber station (SS) Basic Capability Request (SBC-REQ), and the SS Basic Capability Response (SBC-RSP) messages.

| | | | | |
|---|---|---|---|---|
| Extended | 184 | 1 | Bit 0: This bit describes the capability to | SBC- |
| capability | | | support ARQ Map Last Bit concept and | RSP |
| | | | the optimized Sequence Block as defined | SBC- |
| | | | in Table 167. The feature is enabled only | REQ |
| | | | in case both MS and BS support it. | |
| | | | Bit 1: MOB-SLP_REQ/RSP with “MAP | |
| | | | relevance” bit supported. | |
| | | | Bits 2-7: Reserved, set to zero. | |

The MCBCS initiation procedures that are supported can be indicated by adding the following underlined and bolded text to TLV 184:

| Name | Type | Length | Value | Scope |
|---|---|---|---|---|
| Extended | 184 | 1 | Bit 0: This bit describes the | SBC- |
| Capability | | | capability to support ARQ Map | RSP |
| | | | Last Bit concept and the optimized | SBC- |
| | | | Sequence Block as defined in | REQ |
| | | | Table 169. The feature is enabled | |
| | | | only in case both MS and BS | |
| | | | support it. | |
| | | | Bit 1: This bit indicates the | |
| | | | capability to use DSx procedure | |
| | | | to support MBS. | |
| | | | Bit 2: This bit indicates the | |
| | | | capability to use R2 interface | |
| | | | signaling procedure to support | |
| | | | MBS. | |
| | | | Bits 3-7: Reserved, set to zero. | |

Method for Supporting DSx and R2

As shown in FIGS. 1 and 2, when the SS 102 enters 201 the cell 103, the SS exchanges 202 SBC-REQ and SBC-RSP messages with the BS 101. The message indicate 203 whether the SS and the BS support DSx 205 and/or R2 206. Then, the MBS can be used for subsequent message exchanged between the SS and the BS after the SS is admitted into the cell.

When the SS 102 initiates to receive multicast-broadcast service (MBS), the BS or the SS can initiate either a Dynamic Service Addition/Change (DSA/DSC) (DSx)) procedure 240, or the R2 Interface Signaling procedure 230, if both BS and MS support the procedure defined in bits 1 and 2 of the extended capability in the SBC-RSP.

In the case of R2 Interface signaling procedure 230, and the SS configures 208 MBS by R2, the SS notifies that MBS is configured 260 for R2.

In the case of DSx signaling procedure 240, the procedure is used to initiate bi-directional layers communication between the SS and the network for the purpose of configuration of the MBS.

At end, the SS either does use the MBS 209, or the SS receives using the MBS 210.

A detailed interpretation of bit 1 and 2 in the extended capability TLV 148 in an SBC-REQ message sent from an SS to the BS is provided in Table 1.

TABLE 1

| Interpretation | Bit 1 | Bit 2 |
|---|---|---|
| The SS does not support MBS service | 0 | 0 |
| The SS only supports MBS service initiation by using R2 | 0 | 1 |
| Interfance Signaling procedure | | |
| The SS only supports MBS service initiation by using DSx | 1 | 0 |
| procedure | | |
| The SS supports MBS service initiation by using both R2 | 1 | 1 |
| Interfance Signaling procedure and DSx procedure. | | |

A detailed interpretation of bit 1 and 2 in the extended capability TLV 184 in an SBC-RSP SBC-RSP messages 202 between the BS to an SS is provided in the Table 2 below.

TABLE 2

| Interpretation | Bit 1 | Bit 2 |
|---|---|---|
| The BS does not support MBS service | 0 | 0 |
| The BS only supports MBS service initiation by using R2 | 0 | 1 |
| Interfance Signaling procedure | | |
| The BS only supports MBS service initiation by using | 1 | 0 |
| DSx procedure | | |
| The BS supports MBS service initiation by using both R2 | 1 | 1 |
| Interfance Signaling procedure and DSx procedure. | | |

Indication in REG-REQ/RSP

The Registration Request (REG-REQ), and Registration Response (REG-RSP), which is used in REG-REQ and REG-RSP messages 204 can also be used to specify whether the DSx signaling procedure or the R2 signaling procedure 260 is used for MCBCS.

Specifically, the changes are described for Section 12.1.1.4.7 REG-REQ in the IEEE 802.16 Rev 2 Draft 6:
MBS Flow Control (default=DSx signaling).

As an alternative, the default value 212 can be set to R2 interface signaling 230, depending on the capabilities and preference of the BS by changing operator's capability and preference by changing Section in Sec. 12.1.1.4.8 REG-RSP in the IEEE 802.16 Rev 2 Draft 6:
MBS Flow Control (if present in REG-REQ or changed from default)

The encoding for the MBS Flow Control is defined in REG-REQ/RSP Management Message Encodings, see Section 11.7 of the IEEE 802.16 Rev 2 Draft 6. In the Draft 6, TLV 12, 17, 18, 19, 38 and 39 are unused and reserved, an example is shown for introducing the MBS Flow Control into TLV 12 in Table 4.

TABLE 3

| Type | Length | Value | Parameter | Scope |
|---|---|---|---|---|
| 12 | 1 | 0 = DSx procedure is used | MBS Flow | REG-REQ, |
| | | to support MBS (default). | Control | REG-RSP |
| | | 1 = R2 interface signaling | | |
| | | procedure is used to support | | |
| | | MBS. | | |

As an alternative, an extended signaling mechanism can be used as shown in Table 4.

TABLE 4

| Type | Length | Value | Parameter | Scope |
|---|---|---|---|---|
| 12 | 1 | bit 0: the use of DSx | MBS | REG-REQ, |
| | | signaling procedure for MBS | Flow | REG-RSP |
| | | is supported and preferred | Control | |
| | | (default = 1) | | |
| | | bit 1: the use of R2 interface | | |
| | | signaling procedure is | | |
| | | supported and can be used | | |
| | | (default = 0) | | |
| | | bits 2-7: reserved, shall be | | |
| | | set to zero | | |

A detailed interpretation of bit 0 and 1 in the extended MBS Flow Control TLV in an REG-REQ message sent from an SS to the BS are provided in Table 5.

TABLE 5

| Interpretation | Bit 1 | Bit 2 |
|---|---|---|
| Invalid, REG-REQ should only be sent when at least one | 0 | 0 |
| procedure for MBS is supported | | |
| SS proposes to use R2 interface signaling procedure, and | 0 | 1 |
| it cannot support DSx signaling | | |
| SS proposes to use DSx signaling procedure, and it cannot | 1 | 0 |
| support R2 interface signaling procedure | | |
| SS proposes to use DSx signaling procedure, and it can | 1 | 1 |
| also support R2 interface signaling procedure if SS wants | | |
| to use it. | | |

A detailed interpretation of bit 0 and 1 in the extended MBS Flow Control TLV in an REG-RSP message sent from the BS to an SS are provided in Table 6.

TABLE 6

| Interpretation | Bit 1 | Bit 2 |
|---|---|---|
| The BS does not support MBS service | 0 | 0 |
| The BS decides to use R2 interface signaling procedure | 0 | 1 |
| for MBS (only valid if SS sends 10 or 11 in REG-REQ) | | |
| The BS decides to use DSx signaling procedure for MBS | 1 | 0 |
| (only valid if SS sends 01 or 11 in REG-REQ) | | |
| Invalid response | 1 | 1 |

As shown in FIG. 2, after the SS 102 enters 201 cell 103, the SS exchanges 204 REG-REQ and REG-RSP messages with the BS 101. The TLV 12 in the REG messages is used to indicate whether the SS and the BS support DSx and R2 procedures. If the capabilities specified by the REG messages are different from those in the SBC messages, then the capabilities specified by the REG messages override 207 those in the SBC messages.

When the SS registers with the BS for receiving 210 MBS, the BS or SS can initiate either the DSx procedure or the R2 Signaling procedure, depending on value set in MBS Flow Control in REG-RSP. In the case of DSA, the procedure is used to initiate bidirectional upper layers communication between the SS and the network for the purpose of configuration of multicast-broadcast service.

In the case of R2 interface signaling procedure, the SS notifies 260 the BS that the SS has joined the multicast-broadcast service 210, and that the MBS has been configured.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for signaling in a wireless network including a base station (BS) in a cell, wherein the network operates according to the IEEE 802.16 standard, comprising:
exchanging messages between a subscriber station (SS) when the SS enters the cell; and
indicating in the messages a capability of whether the SS and the BS are enabled to use an Upper Layer Signaling (R2) and a Dynamic Service Addition/Change (DSA/DSC) signaling (DSx) to use multi-cast broadcast services (MBS) for subsequent message exchanged between the SS and the BS after the SS is admitted into the cell.

2. The method of claim 1, wherein the SS and BS indicate the R2 and the DSx signaling capability, further comprising:
exchanging a SS Basic Capability Request (SBC-REQ) message and a SS Basic Capability Response (SBC-RSP) between the SS and the BS when the SS enters the network, wherein the Basic Capability messages indicate whether the SS and the BS capability of using the RS and the DSx to enable the MBS.

3. The method of claim 1, wherein the SS and BS indicates R2 and DSx signaling capability, and further comprising:
registering the SS with the BS using a Registration Request (REG-REQ) message and a Registration Response (REG-RSP) message indicating whether the SS and the BS are capable of using the RS and the DSx to enable the MBS.

4. The method of claim 1, wherein the SS and BS indicate whether the SS and the BS: do not support the MBS, only support the MBS service initiation using the R2, only supports the MBS using the DSx, or support the MBS initiation using the R2 and the DSx in a type-length-value (TLV) element 184 of SBC-REQ and SBC-RSP of the IEEE 802.16 standard.

4. The method of claim 1, further comprising:
comparing if the indications of the exchanging and the registering are different;

5. The method of claim 3, further comprising:
overriding the indication of exchanging with the indication of the registration if true.

6. The method of claim 1, wherein a TLV 12 of REG-REQ and REG-RSP of the IEEE 802.16 standard is used to indicate whether the DSx or the R2 is used to support the MBS.
